(19) United States
(12) Patent Application Publication
(10) Pub. No.: US 2021/0166255 A1
(43) Pub. Date: Jun. 3, 2021

(54) BUYER AND SELLER INTERACTION SYSTEM

(71) Applicant: QWQER LLC, Sarasota, FL (US)

(72) Inventor: Tokhir Tokhtabaev, Bradenton, FL (US)

(21) Appl. No.: 17/109,811

(22) Filed: Dec. 2, 2020

Related U.S. Application Data
(60) Provisional application No. 62/942,367, filed on Dec. 2, 2019.

(51) Int. Cl. G06Q 30/02; G06Q 30/06; G06Q 20/32

(52) U.S. Cl. CPC G06Q 30/0208; G06Q 20/3272; G06Q 30/0236; G06Q 30/0643

(57) ABSTRACT

A new system attracts users to purchase products on an online retail platform while actively promoting these products. This new system is a form of social currency that, upon its utilization, loads a predetermined amount of currency to be stored within an e-wallet to be applied as a deduction to a user's final purchase. Additionally, this new system uses a method to actively promote products to users through the collection and analysis of data to recommend relatively interesting products to a specific user based upon previous purchases.

### CROSS-REFERENCE TO RELATED PATENT APPLICATION

This patent application claims priority to U.S. Provisional Patent Application Ser. No. 62/942,367, filed on Dec. 2, 2019, the entire disclosure of which is hereby incorporated herein by reference.

### FIELD

The present invention relates generally to a system and method for online shopping. In particular, the invention is directed to a social currency and active promotion of products to users.

### BACKGROUND OF THE INVENTION

The Internet has enabled online shopping, which has become popular because of its ease of use and fast processing. Further, it enables users to track down the vendors of a product online, and provides them with the ability to instantly compare prices. This has made online shopping time-efficient and convenient in comparison to conventional shopping. Search algorithms on the Internet help users to find any product from the multitude of products available online. Hence, a user can easily collect information about a product of their choice and purchase it accordingly.

When purchasing products, many online retail platforms provide a virtual shopping cart for holding items selected for purchase. Successive items selected for purchase are placed into the virtual shopping cart until the user completes their shopping session. Virtual shopping carts may be examined at any time, and their contents can be edited or deleted at the preference of the user. Once the user decides to check-out of the virtual shopping cart and purchase the products, the user is provided with a virtual receipt documenting the transaction.

However, as innovations continue to advance online shopping, continuously making it more accessible to the user, an algorithm that actively promotes goods to users based upon their previous purchases has yet to be realized.

A new system that monetarily incentivizes users at every step through the purchasing process (e.g. from the initial selection of a product option to its final purchase) through a social currency has yet to be realized.

Surprisingly, in accordance with the invention, a social currency and active promotion of products to users meets all of the above requirements.

Thus, it is highly desirable to provide a systematic algorithm that allows the tracking of previous user purchases with the purpose of then utilizing this data to recommend relevant merchandise to that specific user based on this information. It is also desirable to incentivize the user to purchase these products with a social currency that, upon its utilization, loads a predetermined amount of currency to be stored within an e-wallet to be applied as a deduction to the user's final purchase.

### SUMMARY OF THE INVENTION

Consistent and consonant with the present invention, a new system to attract users to purchase products on an online retail platform while actively promoting the products has surprisingly been discovered.

This new system is a form of social currency that, upon its utilization loads a predetermined amount of currency to be stored within an e-wallet to be applied as a deduction to a user's final purchase. Additionally, this new system uses a method to actively promote products to users through the collection and analysis of data to recommend relatively interesting products to that specific user based upon their previous purchases.

According to an embodiment of the present invention, an online retail platform comprises an interactive graphical interface displaying at least one item for sale with each of the items for sale associated with at least one interactive area of the graphical interface, and a social currency configured to be transferred to an account of a user in reaction to the user interacting with a preselected one of the interactive areas. The social currency is configured to be deducted from a sales price of one of the items for sale when purchased by the user.

According to another embodiment of the present invention, a method of operating an online retail platform is disclosed. The method comprises the steps of: providing an interactive graphical interface displaying at least one item for sale, each of the items for sale associated with at least one interactive area of the graphical interface; and transferring a social currency to an account of a user in reaction to the user interacting with a preselected one of the interactive areas, the social currency configured to be deducted from a sales price of one of the items for sale when purchased by the user.

### BRIEF DESCRIPTION OF THE DRAWINGS

The above-mentioned, and other features and objects of the inventions, and the manner of attaining them will become more apparent and the invention itself will be better understood by reference to the following description of an embodiment of the invention taken in conjunction with the accompanying drawings, wherein:

FIG. 1 is an illustration of a home page of an online retail platform according to the present invention;

FIG. 2 is an illustration of the home page illustrating the functionality of a social currency defined as a Q-dollar;

FIG. 3 is an illustration of a product page of the online retail platform;

FIG. 4 is an illustration of the product page showing the functionality of the Q-dollar relative to an add to cart selectable option (e.g. interactive area);

FIG. 5 is an illustration of the product page showing the functionality of the Q-dollar relative to a buy now selectable option (e.g. interactive area);

FIG. 6 is an illustration of a check out page of the online retail platform showing how the Q-dollar applies to a purchase; and

FIG. 7 is a flowchart illustrating the functionality of a promotion algorithm.

### DETAILED DESCRIPTION OF THE PREFERRED EMBODIMENT

The following detailed description and appended drawings describe and illustrate various exemplary embodiments of the invention. The description and drawings serve to enable one skilled in the art to make, and use the invention, and are not intended to limit the scope of the invention in any manner. With respect to the methods disclosed, the steps presented are exemplary in nature, and thus, the order of the steps is not necessary or critical.

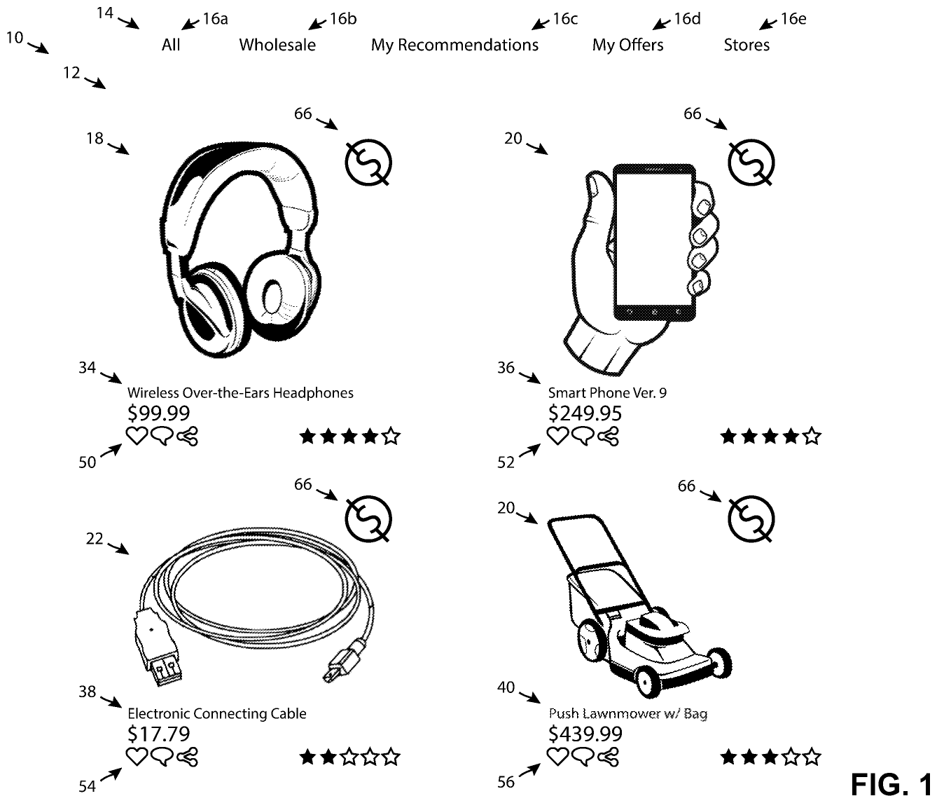

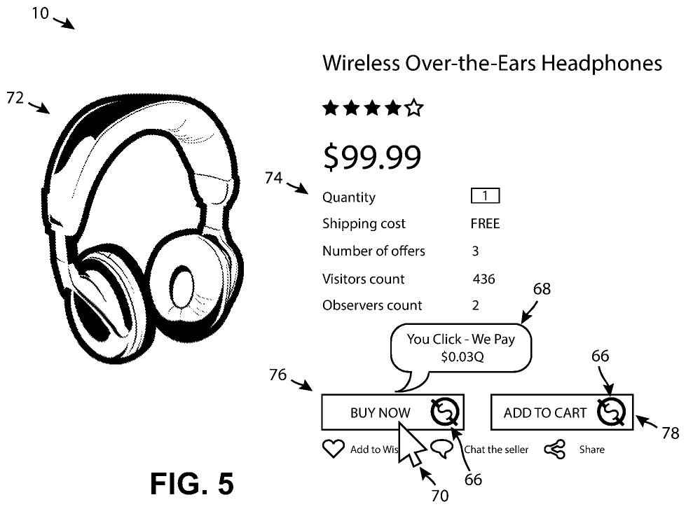

FIGS. 1-6 show an exemplary online retail platform 10 utilizing the transfer of social currency for increasing interaction with the retail platform 10. The retail platform 10 may be accessed by any smart device having Internet connectivity, a suitable browser and/or application compatible for communicating with the retail platform 10, and a suitable user interface for interacting with the retail platform 10 in a desired manner. The smart devices may include desktop computers, laptop computers, smart phones, smart tablets, smart watches, or the like. The retail platform 10 as shown and described hereinafter may be representative of a browser accessible webpage or may be representative of the interface of an application operating on the smart device and capable of carrying out the same functions as the browser accessible webpage.

The use of a desktop or laptop personal computer may facilitate the use of a display screen as a graphical interface for viewing the retail platform 10 and a mouse or similar pointing mechanism for moving a cursor about the graphical interface. Interactions with the graphical interface may be facilitated by the user clicking a button of the mouse (or similar component of a corresponding pointing mechanism) when the cursor is overlaying or pointing to a desired area of the graphical interface. Interactions may otherwise occur by allowing the cursor to hover over the desired area of the graphical interface for a given period of time. One skilled in the art should understand that any number of user initiated actions may be taken to interact with a desired area of the graphical interface, including prescribed cursor movements, button presses or combinations, or the like, while remaining within the scope of the present invention.

As used hereinafter, portions of the graphical interface that are preprogrammed for user interaction may be referred to as the interactive areas of the graphical interface. The interactive areas of the graphical interface are generally identified by the user as images (icons) or text blocks indicative of the user making a selection with respect to the content displayed on the graphical interface. Interaction with one of the interactive areas is generally understood to cause the changing of the display of the graphical interface, such as by redirecting the retail platform 10 to display a new webpage related to the selected interactive area, animating the interactive area to indicate the selection has taken place, bringing up a dialogue box or the like describing the result of selecting the interactive area, or the like, an non-limiting examples.

The retail platform 10 includes the use of images of the items of sale or text blocks describing the items for sale as possible interaction areas capable of user selection. As used hereinafter, the interactive areas are said to be “associated with” a specific topic if an interaction with the interactive area leads to the retail platform 10 displaying information regarding the topic, making a selection regarding the topic, or providing additional means to discuss the topic or otherwise communicate regarding the topic. In the present example, many of the interactive areas of significance when using the retail platform 10 relate to images and text block descriptions of specific items for sale, wherein it is expected that interaction with such interactive areas will lead to the retail platform 10 communicating information directly related to the illustrated or described item for sale. In such a circumstance, the image of the item for sale or the text block describing the item for sale would be described as being “associated with the item for sale” as used herein, and it is expected that interaction with such an interactive area will lead to information regarding the item for sale being accessed or actions being taken regarding the item for sale being proposed by the retail platform 10.

Some of the smart devices suitable for accessing the retail platform 10 may include interaction processes that do not involve the pointing of a cursor via a mouse or the like. Specifically, many smart devices utilize a touchscreen user interface that relies on a touching of the touchscreen at desired positions for interacting with the desired interactive areas of the graphical interface. The touching of the touchscreen may further include multiple successive taps of the touchscreen, a holding of the contact with the touchscreen, the use of multiple touch locations on the touchscreen, or the like. It should be readily apparent to one skilled in the art that each of the subsequent examples utilizing a cursor movement and mouse click interactive process may be easily adapted for a screen touching interactive process without departing from the scope of the present invention. Any method or process suitable for interacting with a specified portion of a graphical interface displaying the retail platform 10 via a corresponding smart device may be utilized while appreciating the benefits of the present invention.

The use of the retail platform 10 as described hereinafter may include the user creating a user account associated with the user's past and future interactions with the retail platform 10. The user account may be utilized to collect data regarding the manner in which the user traditionally interacts with the retail platform 10, such as a history of past purchases, recent searches, or specific user initiated interactions with the retail platform 10. The user account may also include data regarding the user such as the user's name, billing address, shipping address, payment card information, and the like. As explained hereinafter, the user account may also monitor a balance of any currencies associated with the user account, including the social currency described hereinafter. Such currency may be described herein as being placed within an e-wallet of the user, which indicates that a quantity of the currency is understood as being under the control of the user and available for transfer or redemption when the user has accessed their user account.

FIGS. 1-6 represent the relevant portions of a graphical interface used to display the retail platform 10, such as the portions of a display screen or monitor of an associated smart device accessing the retail platform 10, throughout a process of using the retail platform 10 according to the present invention. However, it should be understood that the illustrated retail platform 10 is merely exemplary of one possible embodiment thereof, hence the retail platform 10 is in no way limited to the disclosed layout or workflow pattern indicated by the accompanying figures. It should also be apparent to one skilled in the art that the exemplary interactions performed with respect to the retail platform 10 as described herein may be adapted for use with substantially any user interface utilizing any interactive process while remaining within the scope of the present invention.

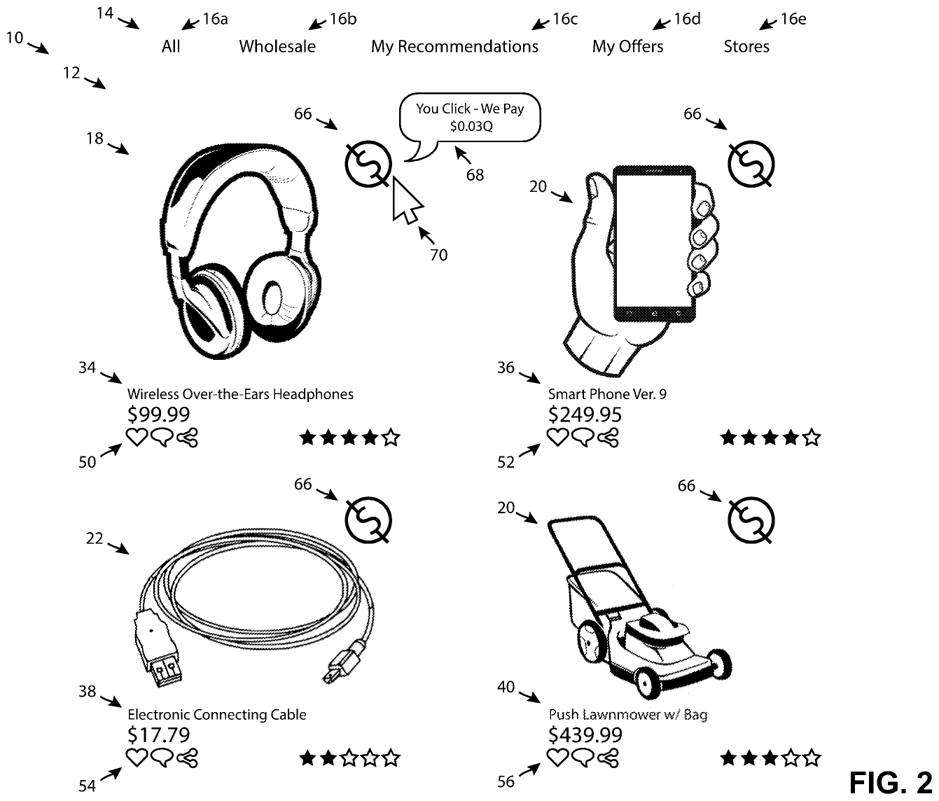

FIGS. 1 and 2 show what may be considered a sales presentation area of the retail platform 10 that may be automatically generated for the specific user based on information stored to the instantaneous user account or may be generated by the user by performing a search for certain items or terms related to such items. The items are available from an associated online retailer through interaction with the retail platform 10.

An individual item display area 12 displays each item for sale in the identified collection of items. A product category selection area 14 includes product category selection controls 16a-16e (e.g. interactive areas) that allow a user to select the product category by which to display the items included in the collection for display on the retail platform 10. For example, the selection of the wholesale button 16b displays the items in the collection on the retail platform 10 that are available to be sold at a wholesale price (e.g. a cheaper price that would be offered if bought in volume numbers, comparable to a single purchase).

The example retail platform 10 shows online items 18, 20, 22, 24 as available for sale from the online retailer. Each online item 18, 20, 22, 24 has associated with it a respective product description area 34, 36, 38, 40 that includes descriptive information relative to each specific item (e.g. item name, item price, item overall user rating, etc.). Additionally, this product description area 34, 36, 38, 40 has associated with it communicative controls 50, 52, 54, 56 (e.g. interactive areas) that allow the user to interact with a seller or other users (e.g. a ‘wish-list’ icon, a chat icon, and a share icon).

The retail platform 10 utilizes what is referred to herein as a social currency for rewarding certain interactions with the retail platform 10. The social currency is a form of digital currency capable of being transferred when making a transaction (purchase) through the retail platform 10. The social currency may be maintained by the retail platform 10 or the retail platform 10 may have access to a remote entity maintaining the social currency. The social currency may utilize blockchain technology to allow for decentralized maintenance of the social currency or the social currency may be directly maintained by the retail platform 10 or a related entity, such as the retail platform associating the balance of the social currency with each user account and corresponding e-wallet following each interaction of the user with the retail platform 10.

The social currency referenced in the present example is indicated as “Q-money,” which is provided by a quantity of Q-dollars. Each Q-dollar ($1.00Q) may be equal in value to one U.S. dollar ($1.00), but any exchange rate with respect to any form of currency, including other digital currencies (such as cryptocurrencies), may be utilized while remaining within the scope of the present invention. The Q-dollars are transferrable to the e-wallet of the user of the retail platform 10 in response to the user taking certain actions (i.e. interacting with certain interactive areas of the graphical interface) or is transferrable from the e-wallet of a user (buyer) to a seller for making a purchase through the retail platform 10. Those interactive areas of the graphical interface associated with the transfer of the Q-dollars may be indicated by a currency symbol 66. In the present example, the currency symbol 66 is embodied as a slanted and encircled dollar symbol, although it is understood any symbol or symbols can be used to indicate such interactive areas leading to the transfer of a quantity of the Q-dollars or other digital currency.

Upon the interaction with such a currency symbol 66, a predetermined amount of the social currency will be stored within the e-wallet of the user or otherwise associated with a balance maintained by the user. This currency is then applied as a deduction to a purchase subsequently made by the user. As shown in FIG. 2, the value of this amount is apparent for the user to see as a pop-up window 68 upon hovering over the currency symbol 66 with a cursor 70 (assuming the use of a pointing device such as a mouse). Other interactive processes may be carried out with respect to alternative smart devices, such as the use of a press-and-hold touch of an associated touchscreen, as one non-limiting example.

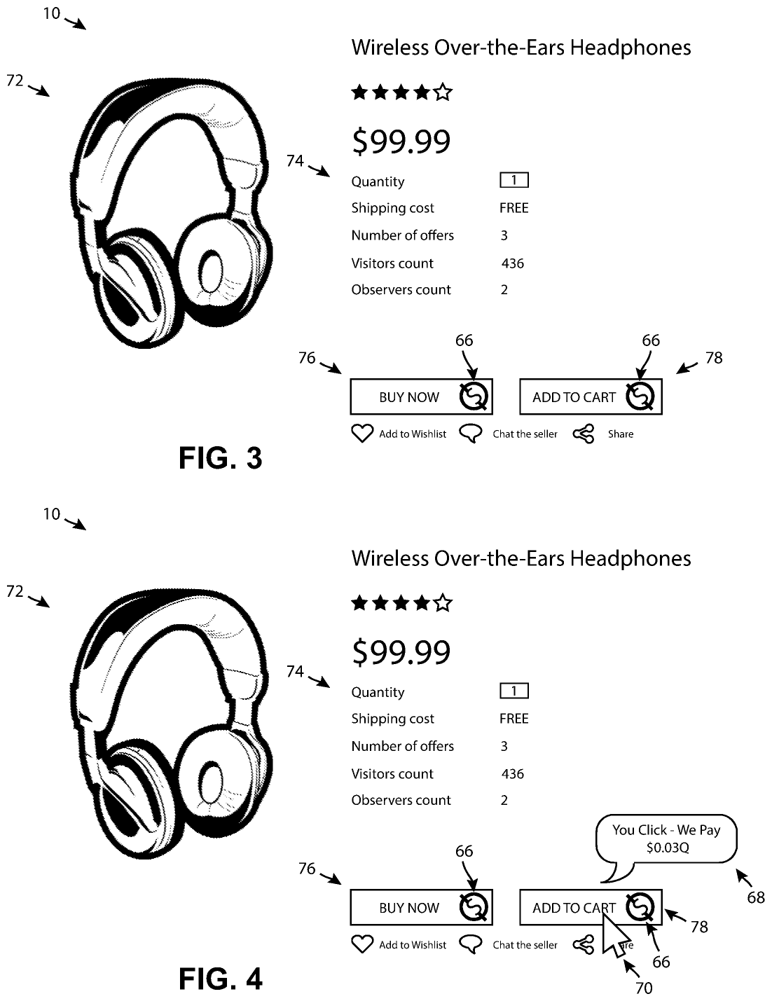

FIGS. 3-5 show a product-specific webpage 72 of the online retail platform 10. The product-specific webpage 72 may be accessed by interacting with (clicking on) an interactive area as displayed on the item display area 12, such as the graphic of the item for sale or the currency symbol 66 disposed immediately adjacent the graphic of the item for sale. The interaction causes the retail platform 10 to redirect the browser/application from the item display area 12 to access and display the product-specific webpage 72 while also crediting the indicated quantity of the Q-dollars to the e-wallet (account) of the user in reaction to the interaction being carried out.

The product-specific webpage 72 has associated with it a purchase-oriented description area 74 that provides the user with necessary details relative to being able to successfully make an informed purchase of that specific product (e.g. item name, item price, item overall user rating, quantity of order, shipping cost, number of offers, visitors count, observers count, etc.). The product-specific webpage 72 is merely exemplary in nature and may display other information relating to the item for sale or may offer other ways to interact with or otherwise make selections regarding the specific item for sale, as desired.

Each of the product-specific webpages 72 has associated with it both a buy now selection option 76 (e.g. interactive area) as well as an add to cart selection option 78 (e.g. interactive area). Each of these selection options 76, 78 have associated with it a currency symbol 66 that, upon the selection of the currency symbol 66, a predetermined amount of social currency will be transferred to the e-wallet of the user with the intention that the social currency will be applied as a deduction to a purchase subsequently initiated by the user. The value of this amount is once again apparent for the user to see as a pop-up window 68 upon hovering over the currency symbol 66 with the cursor 70, respectively, in regards to the buy now and/or the add to cart buttons 76, 78.

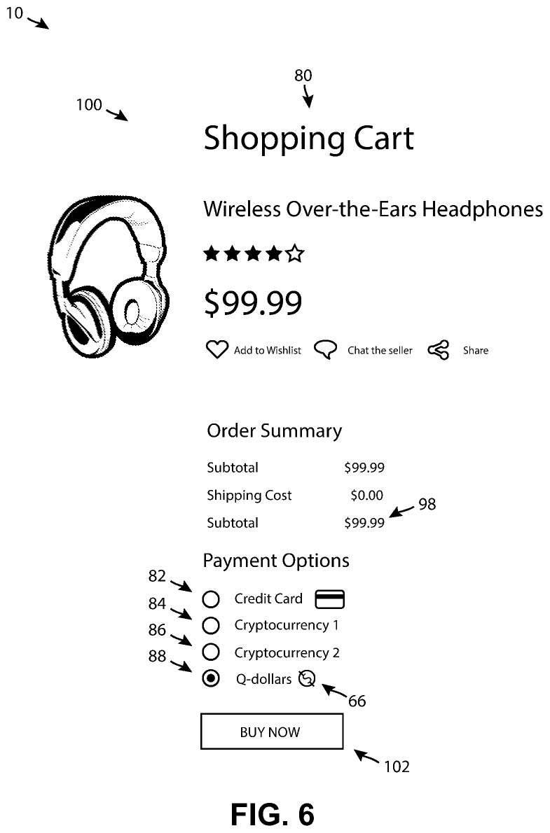

FIG. 6 shows a check-out webpage 80 for the online retail platform 10. This check-out webpage 80 allows the user to finalize the purchase process by reviewing the items in their online shopping cart 100. There are multiple payment options 82, 84, 86, 88 available to the user to be able to purchase the product. The payment option 88 is representative of the Q-dollar amount able to be redeemed towards the purchase of the selected item by deducting the amount of collected Q-dollars from the final purchase price 98 of the selected item for sale. Depending on the price of the item and the quantity of Q-dollars accumulated within the e-wallet of the user, the payment option 88 may completely cover the purchase price or may reduce the balance of the purchase price by the amount of Q-dollars available. At this stage in the process, the user will be able to complete the purchase of the product by selecting the buy now button 102.

The example described with reference to FIGS. 1-6 included the Q-dollars being awarded based on the user accessing information about a specific item for sale and then pursuing the steps necessary to purchase the specific item for sale. The use of the social currency may accordingly drive interaction with the retail platform 10 and improve the odds of a purchase being completed through use of the retail platform 10.

The retail platform 10 may be configured to reward the user with the Q-dollars for a variety of other interactions associated with one of the items for sale besides those directed towards purchasing the item. For example, the communicative controls 50, 52, 54, 56 may act as interactive areas prompting the award of a quantity of Q-dollars to the user. As such, any action taken to place an item into a wish-list, contact a seller for more information, or share a link to an item on an independent social media site or through the retail platform 10 may be rewarded with the Q-dollars.

The retail platform 10 may also be configured to place certain limits on the activities that allow for the transfer and eventual redemption of the Q-dollars towards a purchase price. For example, the retail platform 10 may require that the item for sale is eventually purchased in order to honor any Q-dollars accumulated when interacting with any interactive areas associated with the specific item for sale. As another example, the retail platform 10 may allow for the Q-dollars to be applied to purchases of other items for sale, but may limit such redemptions to similar items or items that are also for sale from a common seller. The retail platform 10 may also limit the number or types of interactions that may be performed in a given time frame or with respect to a given item for sale, as desired.

The interactive areas awarding the Q-dollars may each be associated with a specific item for sale or a specific seller of the items for sale. The retail platform 10 may allow for a seller-selected customization of which interactions with the interactive areas cause the Q-dollars to be transferred to the user with respect to certain items for sale or with respect to all items for sale by the specific seller. The association of the interactive areas with the specific items or sellers of the items allows for the retail platform 10 limit the interactions for which the Q-dollars may be redeemed to certain items or sellers, thereby promoting certain interactions over others.

The retail platform 10 may be configured to allow for an administrator of the retail platform 10 or a seller of items through the retail platform 10 to determine which interactive areas are associated with a transfer of the social currency to the user. In other words, the administrator of the retail platform 10 or the seller may “pay” for the Q-dollars that are to be transferred to the account of the user following interaction with the specified interactive area.

For example, if the administrator of the retail platform 10 is responsible for the payment of the social currency, the administrator may choose certain sellers or certain items for sale from those sellers to include the transfer of the Q-dollars with respect to the administrator-selected interactions. The administrator may establish the quantity of the Q-dollars to be transferred to the user with respect to each specified interaction associated with the item for sale or with the seller of the item for sale. The administrator effectively “pays” for these credits of the Q-dollars by later applying the Q-dollars to the purchase of an item. The administrator of the retail platform 10 may choose to make such payments to promote certain items for sale or certain sellers. For example, sellers having high service ratings based on the quality of the items historically supplied by the seller, the customer service historically supplied by the seller, or the amount of traffic to the retail platform 10 historically driven by the seller may be rewarded by the retail platform 10 by giving the third-party discount to the buyer of such items.

The social currency may instead be paid for directly by the seller as a promotional means for driving traffic towards the items sold by the seller. The seller may, for example, select which interactions are worthy of awarding credits of the Q-dollars and the quantity of the Q-dollars awarded for each such interaction. The retail platform 10 may be configured to give higher priority to those sellers or those items for sale having greater numbers of rewarding interactive areas, higher quantities of the Q-dollars awarded per interaction, a greater history of interaction with the given item for sale, or higher total values of all possible interactions associated with a given seller or item for sale. For example, the retail platform 10 may be configured to prioritize certain items for sale when displaying search results based on the above described factors, wherein such items may be moved to the top of the displayed results to promote greater user interaction therewith. The social currency feature may accordingly act as a form of advertising for the seller that can be purchased from the retail platform 10 via the payment for the Q-dollars to be transferred to the users for interacting with the desired items for sale.

The retail platform 10 may include access to a seller-oriented webpage (not shown) for allowing the seller to upload information regarding a specific item for sale. The information may include an image of the item for sale and other relevant product information regarding the item for sale. The seller-oriented webpage may also facilitate the purchasing of the social currency and the setting of which interactions are associated with the transfer of the social currency, thereby providing the above described advertising feature of the retail platform 10.

The ability to transfer the social currency results in the retail platform 10 providing many benefits that are attractive to both buyers and sellers. The rewarding of certain actions with redeemable credits of the social currency essentially lowers the purchase price of the associated items for sale, hence the retail platform 10 provides a built in cost reduction feature from the perspective of the buyer. The manner in which the credits are redeemed during purchase of an item for sale encourages the buyer to complete the transaction by promising a reward at the conclusion of the transaction. The ability to potentially earn more credits via multiple different interactions with the retail platform 10 with respect to a single purchase also increases buyer engagement and interaction. For example, the prospective buyer may research more items for sale or review more details of the desired item for sale as a result of the extended interaction with the retail platform 10 when trying to acquire more social currency. Such increased interaction can in turn lead to more finalized purchases of the items for sale. Additionally, many interactions with the retail platform 10 lead to the redirecting of the retail platform to new webpages, such as one of the item specific webpages. Each such interaction accordingly provides the ability for the retail platform 10 to promote additional items for sale, present additional online advertisements to the user, better inform the user about a potential item for sale, or otherwise collect more data from the user that can be used to customize future interactions of the user with the retail platform 10. Such actions can drive increased traffic to the retail platform 10.

The retail platform 10 also provides the ability to transfer credits of the social currency from a seller to a buyer in exchange for the sharing of information by the buyer. For example, the seller may compensate the buyer with the social currency credits in exchange for the buyer advertising a product of the seller via the sharing of the product to a social media website. The social currency accordingly aids in drawing users from other websites or the like via a social advertising network.

The ability for the system administrator to selectively distribute the credits to be associated with certain items for sale or to be transferred to certain sellers promotes improved product quality and customer service from the associated sellers. The sellers are also able to effectively provide the buyer with discounts by associating more credits of the social currency with certain items for sale. The sellers can also promote certain items via the manner in which the retail platform maintains the ability to prioritize search results on the basis of the monetary amount and/or the number of possible interactions associated with a specific item for sale or a specific seller.

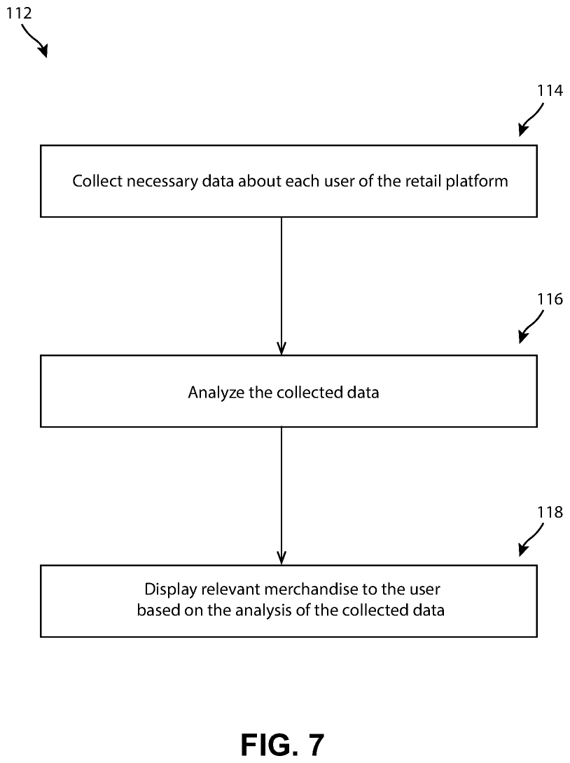

FIG. 7 is a flowchart 112 of an example method of actively promoting products to the users of the retail platform. Necessary data is collected about each user of the system 114 during use of the retail platform 10. For example, upon the successful purchase of a product, the retail platform 10 now would have access to the user's name, previous purchases, and typical interactions made with the retail platform 10. This collected data is analyzed and placed into an algorithm 116. This algorithm utilizes this data and displays a recommended list of products that the user may find of interest, based upon their previous purchases 118.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. An online retail platform comprising:
an interactive graphical interface displaying at least one item for sale, each of the items for sale associated with at least one interactive area of the graphical interface; and
a social currency configured to be transferred to an account of a user in reaction to the user interacting with a preselected one of the interactive areas, the social currency configured to be deducted from a sales price of one of the items for sale when purchased by the user.

2. The retail platform of claim 1, wherein the social currency is a digital currency.

3. The retail platform of claim 1, wherein the social currency is transferred to the user in reaction to the user interacting with one of the interactive areas associated with making a purchase of the item for sale.

4. The retail platform of claim 1, wherein the social currency is transferred to the user in reaction to the user interacting with one of the interactive areas associated with acquiring more information regarding the item for sale.

5. The retail platform of claim 1, wherein the social currency is transferred to the user in reaction to the user interacting with one of the interactive areas associated with sharing information regarding the item for sale to other users of the retail platform.

6. The retail platform of claim 1, wherein the retail platform indicates the value of the social currency to be transferred in reaction to the interacting with the one of the interactive areas.

7. The retail platform of claim 6, wherein the value of the social currency to be transferred is displayed in a pop-up window of the graphical interface.

8. The retail platform of claim 1, wherein a value of the social currency to be transferred to the account of the user is determined by a seller of the item for sale associated with the corresponding interactive area.

9. The retail platform of claim 8, wherein the retail platform prioritizes a displaying of the items for sale based on the value of the social currency to be transferred to the user.

10. The retail platform of claim 1, wherein each of the interactive areas associated with the transfer of the social currency is marked by a symbol visible to the user.

11. A method of operating an online retail platform comprising:
providing an interactive graphical interface displaying at least one item for sale, each of the items for sale associated with at least one interactive area of the graphical interface; and
transferring a social currency to an account of a user in reaction to the user interacting with a preselected one of the interactive areas, the social currency configured to be deducted from a sales price of one of the items for sale when purchased by the user.

12. The method of claim 11, wherein the social currency is a digital currency.

13. The method of claim 11, wherein the social currency is transferred to the user in reaction to the user interacting with one of the interactive areas associated with making a purchase of the item for sale.

14. The method of claim 11, wherein the social currency is transferred to the user in reaction to the user interacting with one of the interactive areas associated with acquiring more information regarding the item for sale.

15. The method of claim 11, wherein the social currency is transferred to the user in reaction to the user interacting with one of the interactive areas associated with sharing information regarding the item for sale to other users of the retail platform.

16. The method of claim 11, wherein the retail platform indicates the value of the social currency to be transferred in reaction to the interacting with the one of the interactive areas.

17. The method of claim 16, wherein the value of the social currency to be transferred is displayed in a pop-up window of the graphical interface.

18. The method of claim 11, wherein a value of the social currency to be transferred to the account of the user is determined by a seller of the item for sale associated with the corresponding interactive area.

19. The method of claim 18, wherein the retail platform prioritizes a displaying of the items for sale based on the value of the social currency to be transferred to the user.

20. The method of claim 11, wherein each of the interactive areas associated with the transfer of the social currency is marked by a symbol visible to the user.
